(19) United States
(12) Patent Application Publication
(10) Pub. No.: US 2018/0106063 A1
(43) Pub. Date: Apr. 19, 2018

(54) TRELLIS ANCHOR BASE SUPPORT AND TRELLIS ANCHORING SYSTEM

(71) Applicant: DE KLEINE MACHINE COMPANY LLC, Prosser, WA (US)

(72) Inventor: Mark E. De Kleine, Prosser, WA (US)

(21) Appl. No.: 15/784,014

(22) Filed: Oct. 13, 2017

Related U.S. Application Data
(60) Provisional application No. 62/408,626, filed on Oct. 14, 2016.

(51) Int. Cl. E04H 12/22; A01G 17/06

(52) U.S. Cl. CPC E04H 12/2269; A01G 17/06

(57) ABSTRACT

A system of anchored structural support elements for use in horticulture, commonly referred to as a “trellis anchor,” as employed to support plant growth in orchards, vineyards, hop fields and the like, in both indoor and outdoor use. The trellis anchor and anchoring system has an anchor base support with a support cradle that extends from a footing to support superstructures. The support cradle receives a trellis pole anchor and the support cradle extends upward and at a support angle.

Multiple anchor base supports with trellis pole anchors assembled in an extended structure, as employed in a plant-support in a collective assembly of stakes, poles, wires and shade structures, water delivery systems, sensors, or similar superstructures.

### TECHNICAL FIELD

A system of anchored structural base support elements for use in horticulture, commonly referred to as a “trellis anchor,” as employed to support plant growth in orchards, vineyards, hop fields and the like, in both indoor and outdoor use.

### BACKGROUND OF THE INVENTION

A trellis is a structure, usually built in the open framework, of a lattice or intersecting elements of wood, metal or cable. Typically, trellises support or train climbing plants, especially small trees, vines, or shrubs. There are many types of trellis modified for specific uses to suit the place and trained plants, from agricultural types, especially in viticulture vine training systems and in fruit tree orchards, and in home or commercial garden uses for climbing plants, such as grapevines, clematis, ivy, climbing roses, creeping vines, or other train-able growing plants.

Some plants naturally climb and wrap themselves around a conventional trellis without much artificial help required, while others need training by passing the growing shoots through the trellis, or tying them to the framework. Generally, a trellis can be in the form of panels, or individual staked elements, usually made from wood, plastic or metal pieces, and anchored into a ground surface, or attached to fences, roofs or the exterior wall of a building. A typical, staked trellis element can include string, wire, lattice, or netting, in providing a framework to support the climbing plant.

Broadly, horticulture is the branch of agriculture that deals with all technical and business aspects of growing plants, specifically including the cultivation of medicinal and food plants, and non-food crops such as ornamentals. Horticulture also encompasses plant conservation, restoration, arboriculture, landscaping and garden design, including the construction, and maintenance of such horticultural systems. Modern horticultural systems require easy access to tree crops and vines, and often employ trellis systems that must be anchored in the ground. However, current trellis and anchor system have several limitations, including difficulties in easy deployment or set-up, high expense and maintenance, and dependence on soil depth for providing a suitable support for anchoring the trellis system.

The present invention addresses these problems and provides the needed easy deployment or set-up, and improved stability in providing a suitable support for anchoring such a trellis system for use in horticulture. Additionally, the following disclosure of the present invention will be understood by reference to the following detailed description, taken in conjunction with the accompanying drawings.

### BRIEF DESCRIPTION OF THE DRAWINGS

FIG. 1 is an isometric view of an anchor base support for use in a trellis anchoring system, according to an embodiment of the invention;

FIG. 2 is a side view of an anchor base support for use in a trellis anchoring system, according to an embodiment of the invention;

FIG. 3 is an isometric view of an anchor base support for use in a trellis anchoring system, according to an embodiment of the invention;

FIG. 4 is a top view of an anchor base support for use in a trellis anchoring system, according to an embodiment of the invention;

FIG. 5 is a front view of an anchor base support for use in a trellis anchoring system, according to an embodiment of the invention;

FIG. 6 is a side view of a pair of anchor base supports with trellis pole anchors in a trellis anchoring system, according to an embodiment of the invention;

FIG. 7 is an isometric view of an anchor base support for use in a trellis anchoring system, according to an embodiment of the invention;

FIG. 8 is an isometric view of an anchor base support for use in a trellis anchoring system, according to an embodiment of the invention;

FIG. 9 is a set of twelve cross-sectional views of trellis pole anchors for use in a trellis anchoring system, according to an embodiment of the invention;

FIG. 10 is an isometric view of a pair of anchor base supports with integral trellis pole anchors connected with a pole-tie in a trellis anchoring system, according to an embodiment of the invention;

FIG. 11 is an isometric view of a trellis anchoring system, according to an embodiment of the invention; and

FIG. 12 is an isometric view of a trellis anchoring system, according to an embodiment of the invention.

Reference characters included in the above drawing indicate corresponding parts throughout the several views, as discussed herein. The description herein illustrates one preferred embodiment of the invention, in one form, and the description herein is not to be construed as limiting the scope of the invention in any manner. It should be understood that the above listed figure is not necessarily to scale and may include fragmentary views, graphic symbols, diagrammatic or schematic representations, and phantom lines. Details that are not necessary for an understanding of the present invention by one skilled in the technology of the invention, or render other details difficult to perceive, may have been omitted.

### DETAILED DESCRIPTION OF SPECIFIC EMBODIMENTS

The present invention is a trellis anchor and anchoring system, especially for use in agriculture, or alternatively in horticulture. The trellis anchor and anchoring system for the present invention are devices designed to support a collective assembly of stakes, poles, wires and shade structures, water delivery systems, sensors, or superstructures referred to herein generally as a “trellis” or “trellis system.” To anchor the trellis, an earth anchor can be employed, which alternatively can be referred to as a ground anchor.

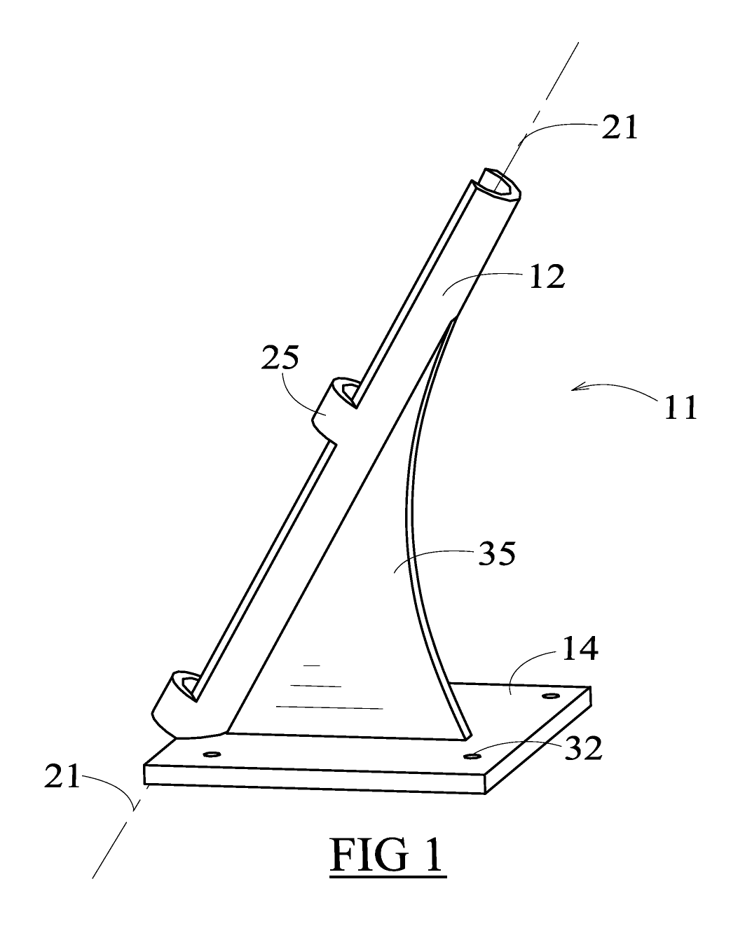

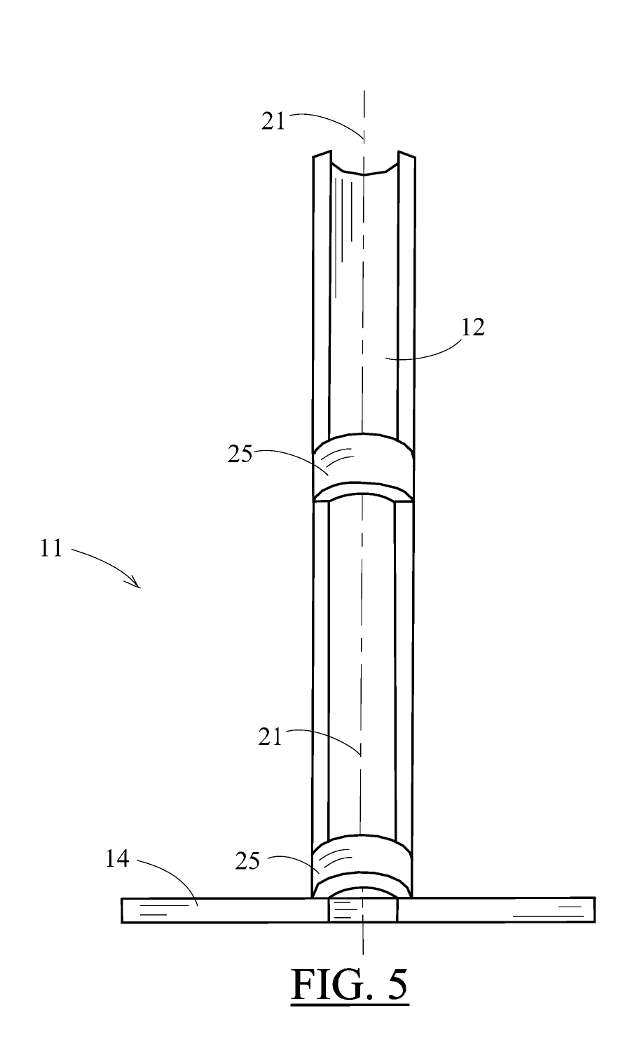

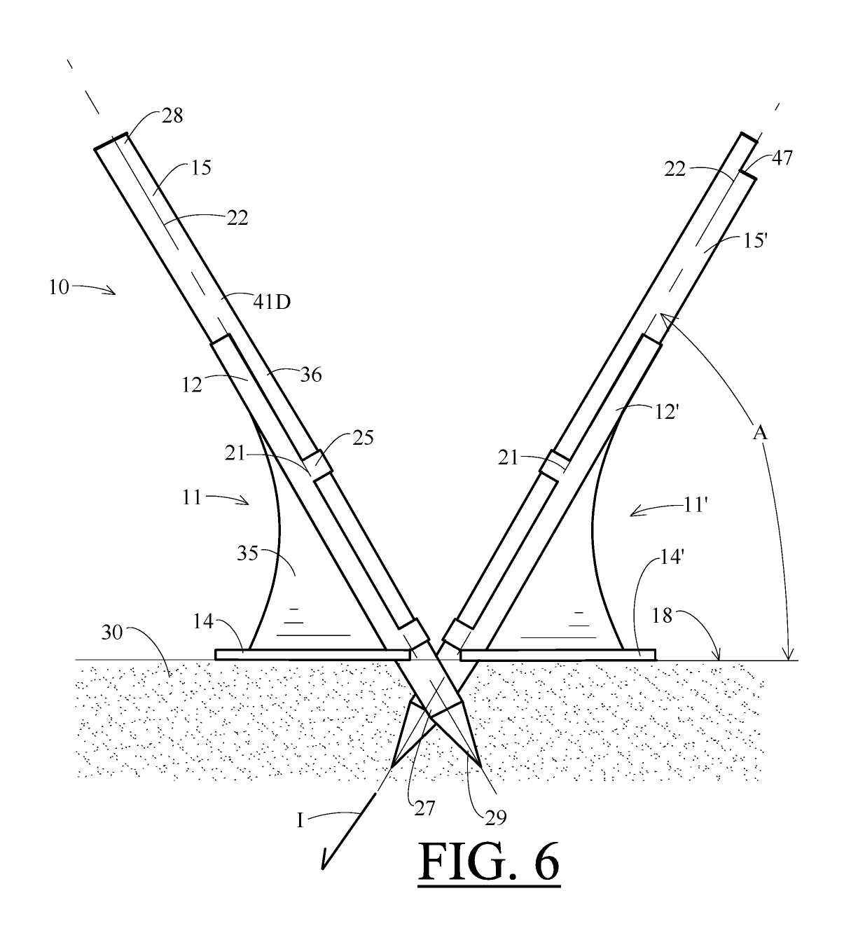

Embodiments and features of the trellis anchor and anchoring system 10 of the present invention are shown in FIGS. 1 through 12. The trellis anchor and anchoring system more simply may be referred to herein as the “trellis anchor.” In a preferred embodiment of the trellis anchor 10 as shown in FIG. 1, the trellis anchor includes an anchor base support 11, which has support cradle 12 that extends from a footing 14. The support cradle receives a trellis pole anchor 15, as shown in FIG. 6. The footing of the trellis anchor sets upon a ground surface 18, and the support cradle extends upward and at a support angle A, as also shown in FIG. 6.

The support cradle 12 of the anchor base support 11 includes a cradle centerline 21 along the length of the support cradle as shown in FIG. 6. When the trellis pole anchor 15 is received within the support cradle, the cradle centerline co-insides with a pole centerline 22 of the trellis pole anchor. The trellis pole anchor is precisely sized and shaped to fit into the support cradle to minimize its movement within the support cradle, except for movement along an insertion vector I. Preferably, the anchor base support has a least one support collar 25, which extends over the support cradle to hold the trellis pole anchor in place, as shown in FIG. 6.

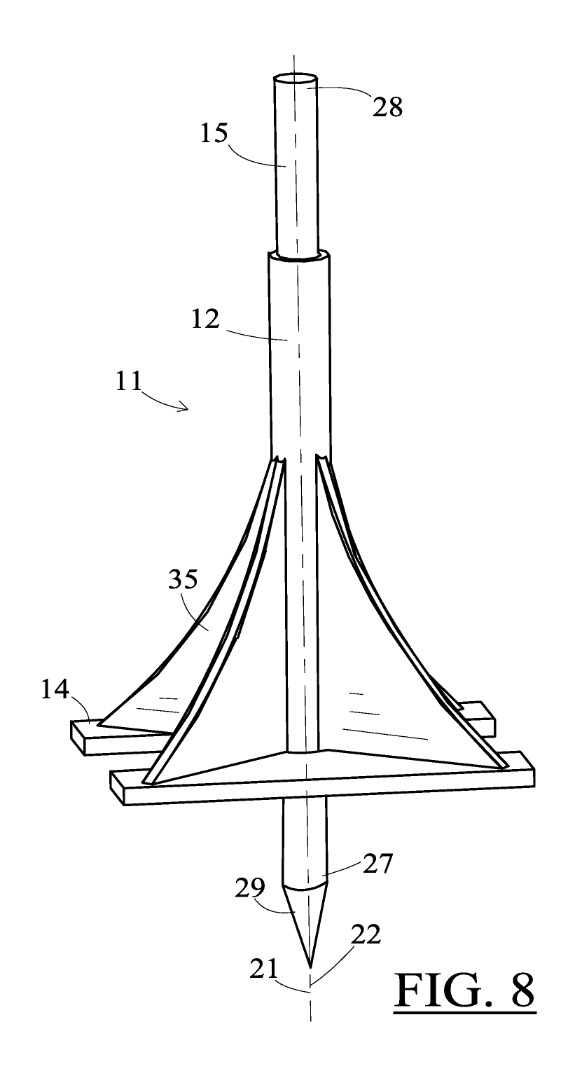

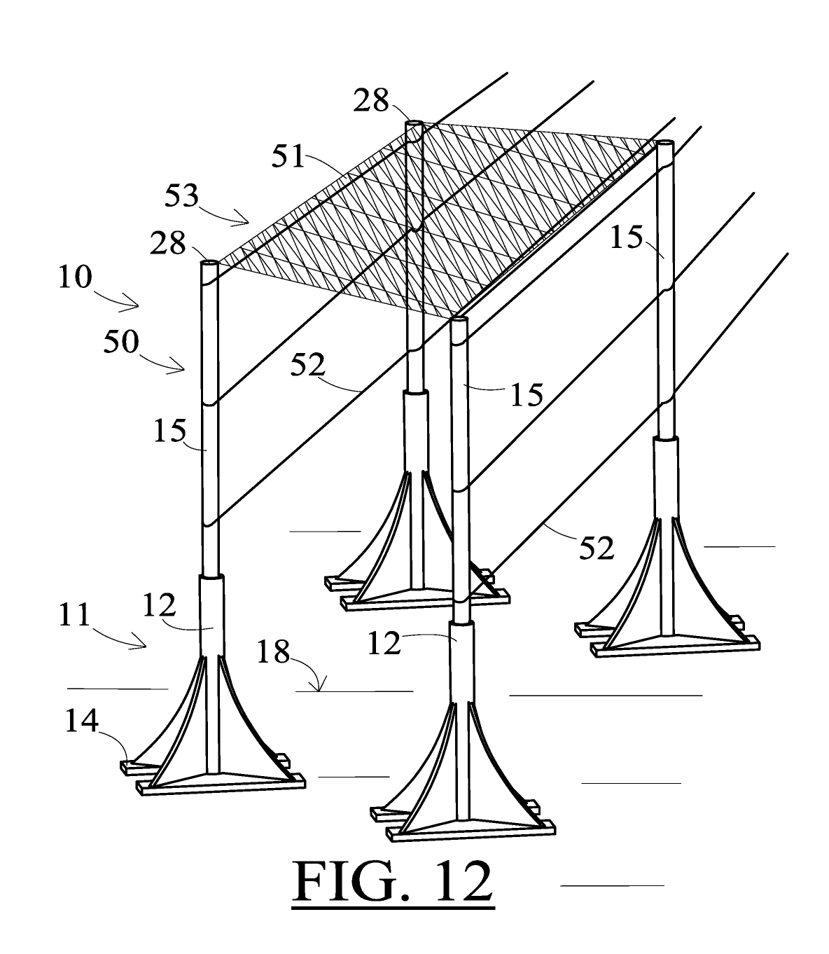

The support angle A of the support cradle 12 in the anchor base support 11 is defined as the angle between the footing 14, as parallel to the ground surface 18, and the collar centerline 21. The support angle can vary relative to the footing from nearly an oblique, low angle of a few degrees, to vertical relative to the ground surface at approximately ninety degrees. A vertical anchor base support and trellis pole anchor is shown in FIGS. 8 and 12. Preferably, the support angle is between thirty and seventy degrees. Most preferably, a rib 35 is employed to aid in holding the support cradle in place, as shown in FIGS. 1 through 3, 6 through 8, and 10, to buttress the support cradle and better connect the support cradle to the footing of the anchor base support. One or more ribs may be included, as with four ribs shown in the vertical embodiment of FIGS. 8 and 12.

The trellis pole anchor 15 has a lower pole end 27 opposite an upper pole end 28, and preferably with an anchor spike 29 at the lower pole end, as shown in FIG. 6. The purpose of the anchor spike is to penetrate through the ground surface 18, when driving the trellis pole anchor into a ground 30 or material that lies beneath the ground surface. As shown in FIG. 6, the insertion vector I is an extension of the cradle centerline 21 of the trellis anchor 10, which matches the pole centerline 22 when the trellis pole anchor is received within the support cradle 12.

The trellis pole anchor 15 can be any supportive pole, the pole defined as any extrusion, post, stake, bar, or pile that can be received within the support cradle 12 of the anchor base support 11 in the trellis anchor and anchoring system 10. Again, the assembled trellis anchor elements can be referred to generally as any anchoring system having the principal objective to provide an improved support for a horticultural system that includes anchor base supports having supportive poles in any relative angle or desired position, thereby providing for a vast variety of combinations for trellis structures of many different configurations and types.

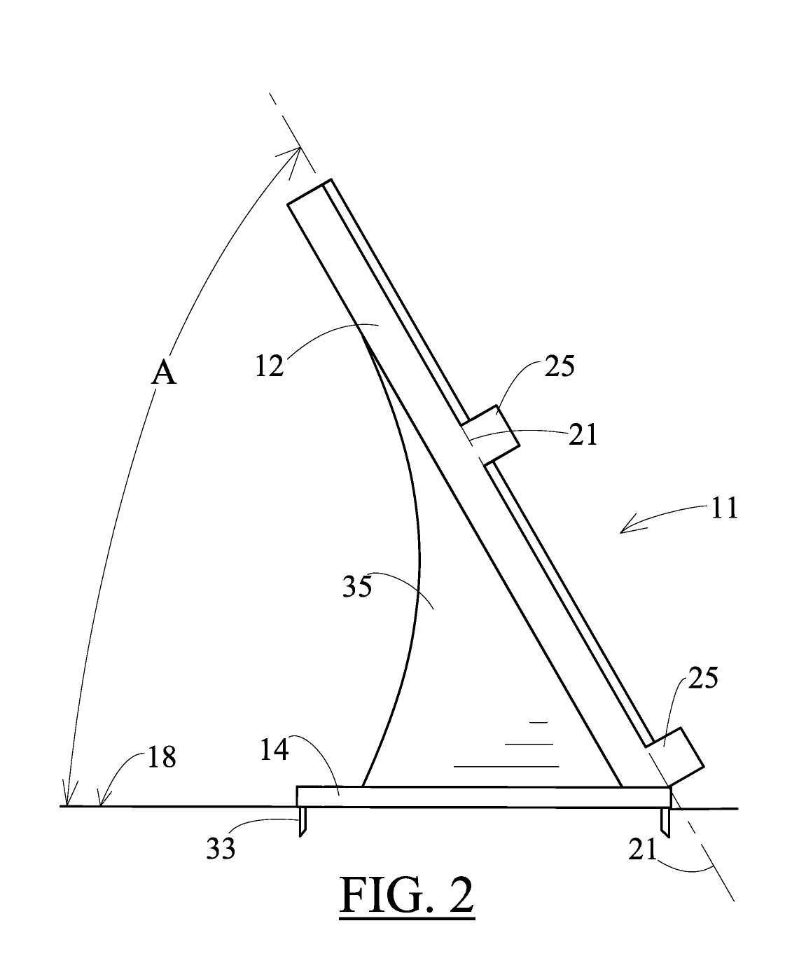

Preferably, the footing 14 of the anchor base support 11 includes a generally square or rectangular base plate, as shown in FIGS. 1 through 8. The footing can vary in shape and dimension, but is sized to keep the anchor base support stable and upright on the ground surface 18. The footing can include footer holes 32, as shown in FIGS. 1, 3, and 4, or one or more footer cleats 33, as shown in FIG. 2. Each of the footer cleats may be either integrated into the footing or separate from the footing, and can be included to secure the base plate to the surface below the footing, typically into the ground 30.

A separate-able footer cleat 33 may be referred to as a footer nail 34. Preferably, as shown in FIG. 1, one or more footer nails 34 are inserted into the footer holes. The footer nails may be plastic or metal, and serve to prevent the footer from shifting on the ground surface 18. The footer holes can also serve to allow mud or moisture to seep up from beneath the footing, and allow the anchor base support to better settle into the ground 30, and prevent the footing from sliding on the ground surface 18.

Similarly to the separate-able footer cleat 33, the trellis pole anchor 15 and the anchor base support 11 preferably are separate and elements, each manufactured independently and assembled for use in the trellis anchor and anchoring system 10. However, in an alternative embodiment of the trellis anchor and anchoring system, the trellis pole with the anchor spike 19 and the anchor base support may be manufactured together as an integrated whole, with the trellis pole either immovable within the support cradle 12 or detachably movable within the support cradle, to move along the insertion vector I.

Preferably, the anchor base support 11 is fabricated from a mixture of polystyrene and concrete but considered as not limited to these materials. Other materials that could comprise the anchor base support in the alternative include wood, plastic, metal, concrete, fiberglass, hemp fiber, and carbon fiber. Most preferably, the trellis pole anchor 15 is fabricated from a polystyrene and concrete mixture, but alternatively a metal, and preferably a steel, aluminum or alloy with high shear strength and high tensile strength. Additional alternative materials for the trellis pole anchor include wood, plastic, metal, concrete, fiberglass, and carbon fiber, but also considered as not limited to these materials.

The anchor base support 11 may be injection molded or possibly generated with a 3D printer. Alternatively, the anchor base support may be fabricated in two halves, and clamped, glued, snapped, or strapped around the trellis pole 15, which may be already inserted into the ground 30. The portion of the support cradle 12 in each half of the anchor base support receives a part of the trellis pole, to result in a structure similar to the preferred, single-piece anchor base support.

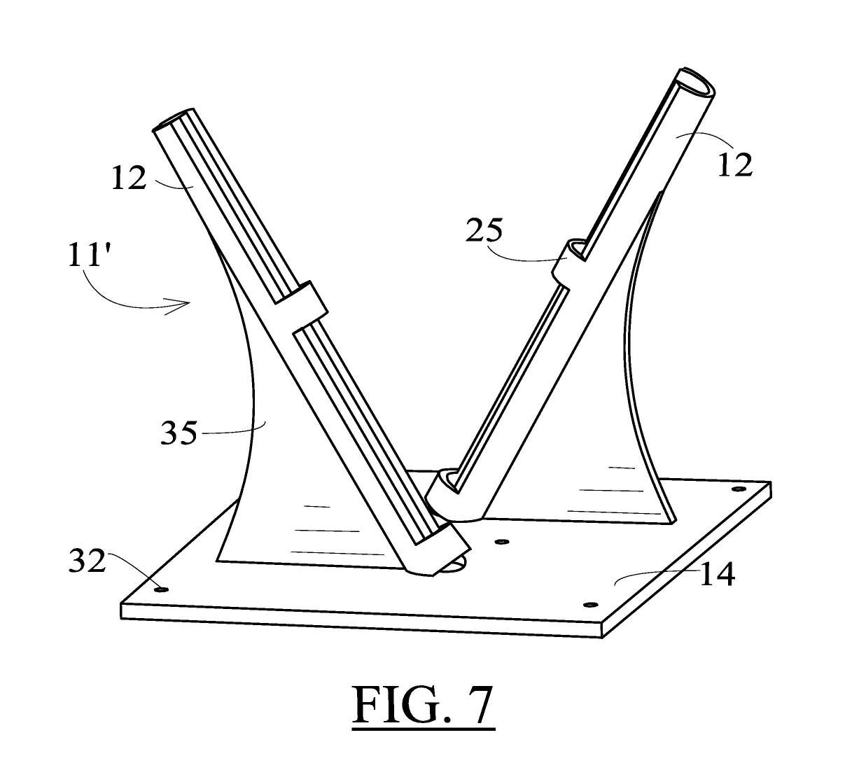

Also alternatively, as shown in FIG. 7, the footing 14 may be extended to include two support cradles 12 in a paired anchor base support 11′. Each of the support cradles in the paired anchor base support can receive a trellis pole 15, as shown in the single anchor base support 11 shown in FIG. 6.

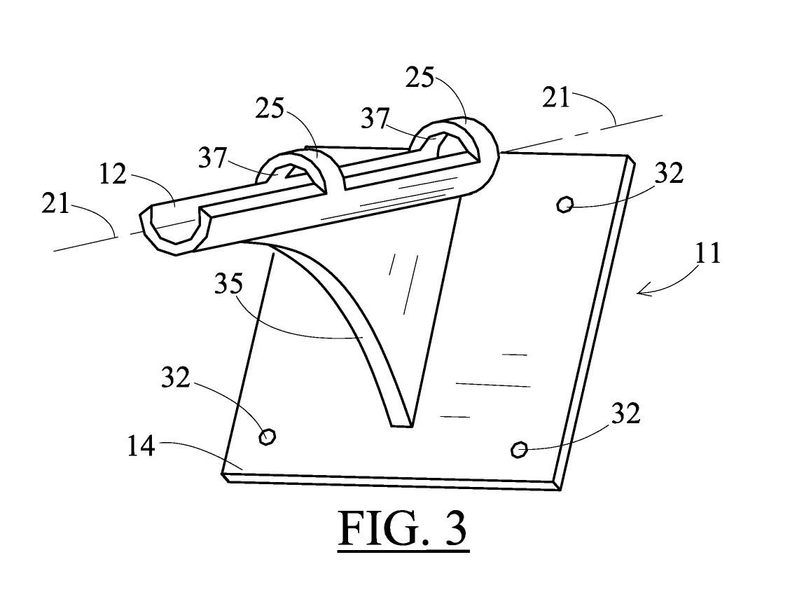

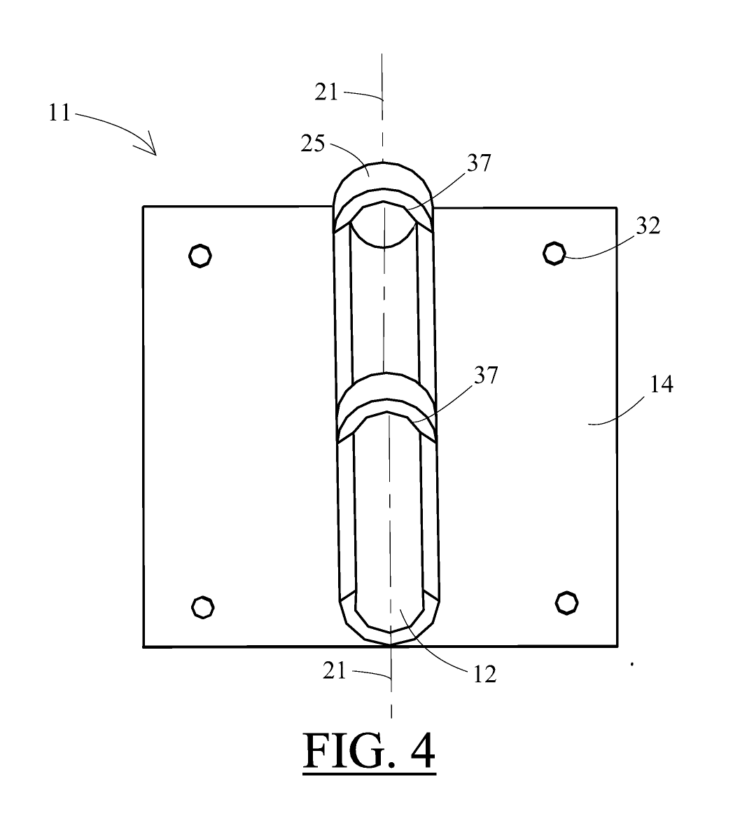

Most preferably, the anchor base support 11 is a trellis building element, with the trellis pole anchor 15 including a geometric extrusion 36, and the support collar 12 including a geometric socket 37, as shown in FIGS. 3 and 4, with the geometric extrusion of the trellis pole anchor able to mate precisely into the geometric socket of the support collar in such a manner that when the trellis pole anchor is inserted into the support collar, the tolerance between the geometric extrusion and geometric socket renders a tight fit between them, with movement of the trellis pole anchor substantially constrained to movement only along the insertion vector I.

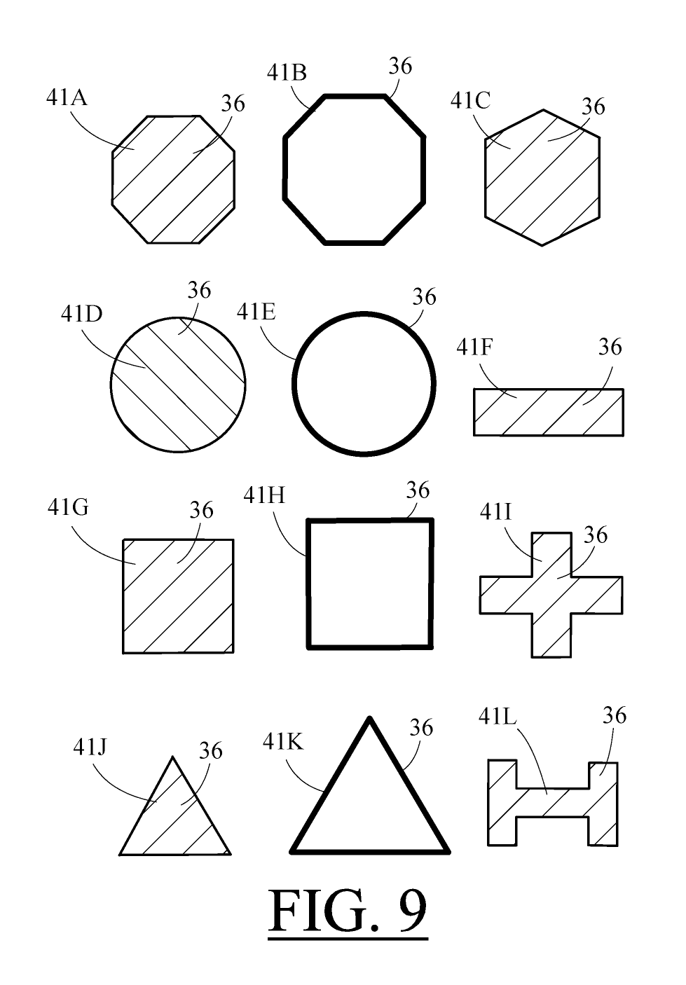

FIG. 9 shows several possible cross-sectional shapes for the geometric extrusion 36 of the trellis pole anchor 15, including a metal, wood or plastic solid form 41A, 41D, 41G, 41J, 41C, and 41F, 41L, and a hollow or tubular form 41B, 41E, 41H, and 41K, which may be made from any conventional material. FIG. 6 shows solid form 41D geometric extrusion 36 of the trellis pole anchor. Additionally, the geometric extrusion may contain internal elements for structural support, including wires, cables, or steel elements. Also, a kerf 46 or channel may be scored, milled, cut or embedded into the trellis pole anchor 15′, as shown in FIG. 6. Clips, material loops, or fasteners, may also be used for additional component mounting points and attachments.

The trellis pole anchor 15 of the trellis anchor 10 may be placed into the ground 30 or earth manually, with a mallet, a pile driver or with a sledge hammer, or with percussion driven or mechanically driven devices, to forcibly drive the trellis pole anchor in the support cradle along the support angle A.

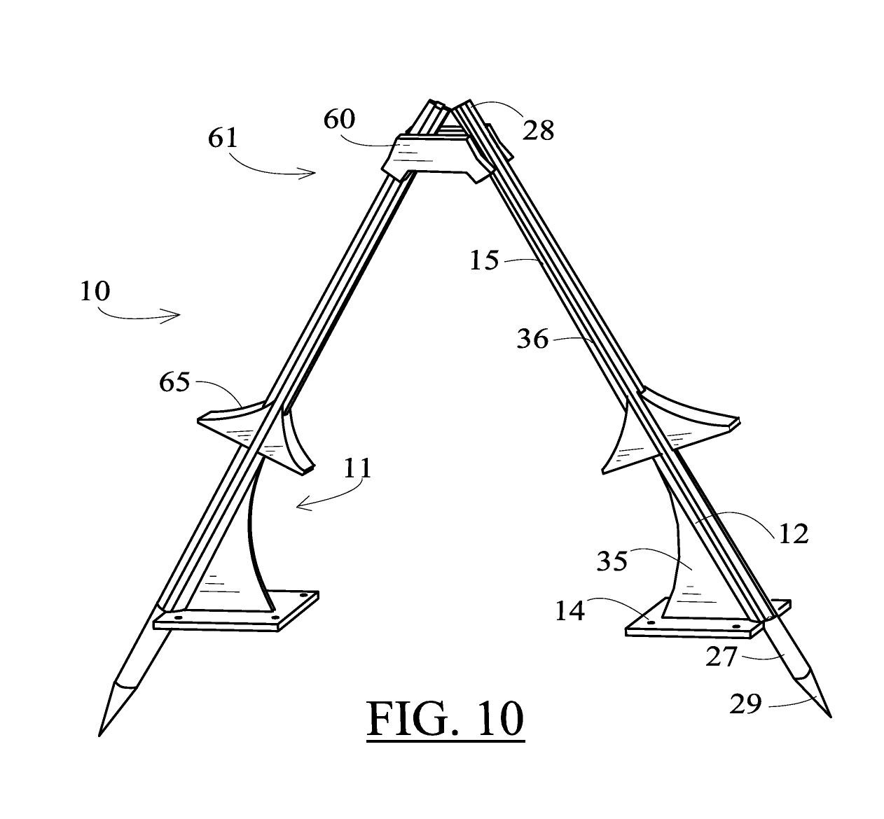

A preferred addition to the trellis anchor and anchoring system 10 is a pole-tie 60, which connects the upper pole end 28 of a pair of the trellis poles 15 is shown in FIG. 10. The pole-tie grasps the upper pole ends to form a trellis pair 61. Preferably, the pole-tie is used with the trellis pole with anchor spike 29 and the anchor base support 11 are an integrated whole, with the trellis pole and anchor spike immovable within the support cradle 12. As also shown in FIG. 10, the integrated trellis pole with anchor spike and anchor base support can include a push extension 65 which extends from the trellis pole at the anchor base support. The push extension aids the setting of the anchor spike into the ground surface 18.

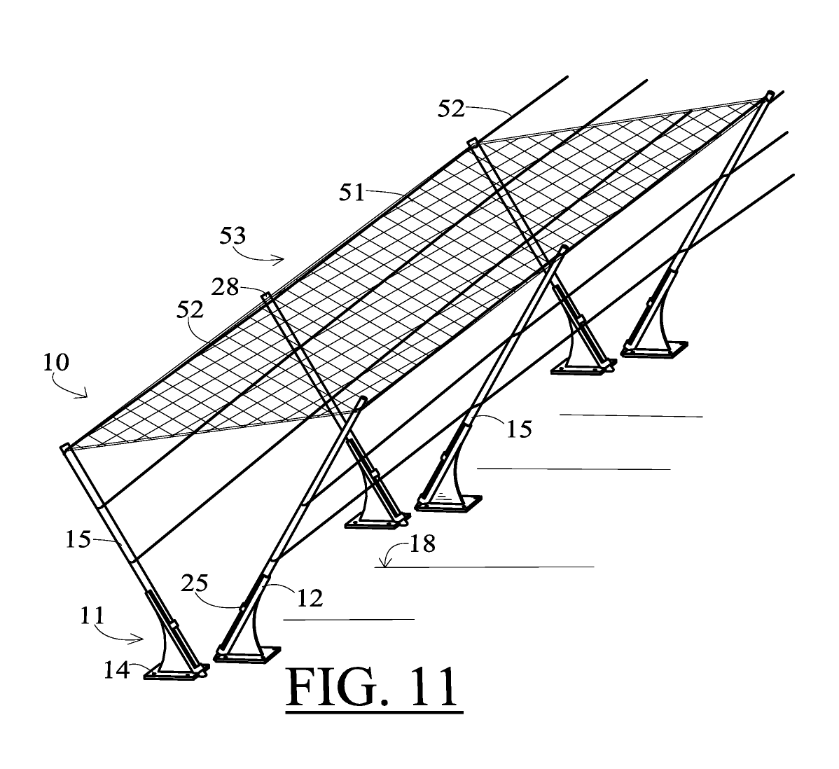

A most preferable example of the trellis anchor and anchoring system 10 is shown in FIGS. 11 and 12, with a multiple of the anchor base supports 11 and the trellis pole anchors 12 assembled in an extended structure 50, which may include a superstructure 51, and one or a multiple of trellis wires 52. The extended structure can be employed in a plant-support 53 application of the trellis anchor. The trellis anchor and anchoring system can be a collective assembly of stakes, poles, wires and shade structures, water delivery systems, sensors, or superstructures that in general are elements of the plant-support. Again, the trellis anchor and anchoring system of the present invention may be utilized in any horticultural crop, especially specialty crops of fruits and vegetables, tree nuts, and nursery crops, including floriculture.

The preferred superstructures 51 used with the trellis anchor shown in FIGS. 11 and 12, may be assembled to or attached proximate to the upper pole end 28 of each trellis pole anchors 15. Additionally, the superstructure may be any wind breaks, screen or shelter employed in the trellis anchor and anchoring system 10. Any conventional shade materials could be employed for the superstructure, including plastic, mesh, canvas, netting, cloth and fabric.

In compliance with the statutes, the invention has been described in language more or less specific as to structural features and process steps. While this invention is susceptible to embodiments in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents. Additionally, the terms “substantially,” “proximate to” and “approximately” may be employed herein throughout, including this detailed description and the attached claims, with the understanding that is denotes a level of exactitude or equivalence in amount or location commensurate with the skill and precision typical for the particular field of endeavor, as applicable.

The following is claimed:

1. A trellis anchor system including:
an anchor base support having a footing and a cradle, the cradle extending from the footing, and the cradle having a cradle centerline along the length of the cradle; and
a trellis pole received into the anchor base support, the trellis pole having a pole centerline, and the cradle centerline co-insides to the pole centerline, with the trellis pole received into the cradle.

2. The trellis anchor system of claim 1, wherein the footing of the anchor base support is set upon a ground surface.

3. The trellis anchor system of claim 1, wherein the trellis pole is precisely sized and shaped to fit into the cradle to minimize movement of the trellis pole within the cradle, other than movement of the trellis anchor within the cradle that is parallel with the cradle centerline.

4. The trellis anchor system of claim 1, additionally including:
a support collar that extends from the collar of the anchor base support, and the support collar extends over the cradle to hold the trellis pole in place, with the trellis pole received into the support collar.

5. The trellis anchor system of claim 1, additionally including:
a support angle formed between the footing of the anchor base support as parallel to the ground surface, and the collar centerline of the cradle; and
the support angle is between thirty degrees and seventy degrees.

6. The trellis anchor system of claim 5, additionally including:
a rib to connect the support cradle to the footing of the anchor base support, the rib to aid in holding the cradle in place relative to the footing and buttress the support cradle to the footing of the anchor base support.

7. The trellis anchor system of claim 1, additionally including an anchor spike attached to the footing of the anchor base support, the anchor spike extending downward into the ground surface.

8. The trellis anchor of system claim 7, additionally including a push extension, the push extension extending from the trellis pole proximate to the anchor base support, and the push extension aids in setting the anchor spike into the ground surface.

9. A trellis anchor system including:
a first anchor base support having a first footing;
a first trellis pole extending from the first anchor base support;
a second anchor base support having a second footing;
a second trellis pole extending from the second anchor base support;
the first trellis pole having a first upper pole end, and the second trellis pole having a second upper pole end;
the first upper pole connected to the second upper pole with a pole-tie; and
the pole-tie grasps the first upper pole end of the first trellis pole, and the pole-tie grasps the second upper pole end of the second trellis pole, to form a paired trellis anchor.

10. The trellis anchor system of claim 9, additionally including:
a first anchor spike attached to the first footing of the first anchor base support, the first anchor spike extending downward into the ground surface; and
a second anchor spike attached to the second footing of the first anchor base support, the second anchor spike extending downward into the ground surface.

11. The trellis anchor system of claim 10, additionally including:
a first push extension, the first push extension extending from the first trellis pole proximate to the first anchor base support, and the first push extension aids in setting the first anchor spike into the ground surface; and
a second push extension, the second push extension extending from the second trellis pole proximate to the second anchor base support, and the second push extension aids in setting the second anchor spike into the ground surface.
